(19) United States
(12) Patent Application Publication
(10) Pub. No.: US 2007/0084931 A1
(43) Pub. Date: Apr. 19, 2007

(54) Handheld barcode reader

(76) Inventors: Hitoshi Watanabe, Saitamai-shi (JP); Hironobu Watanabe, Koshigaya-shi (JP)

Correspondence Address: KAPLAN GILMAN GIBSON & DERNIER L.L.P., 900 ROUTE 9 NORTH, WOODBRIDGE, NJ, 07095, US

(21) Appl. No.: 11/253,014

(22) Filed: Oct. 18, 2005

(51) Int. Cl. G06K 7/10

(52) U.S. Cl. 235/462.45; 235/462.46

(57) ABSTRACT

A handheld barcode reader comprises a scanner portion and a grip portion pivotally connected to each other. Preferably, the grip portion does not include essential electronic components of the barcode reader. Preferably, the grip portion has a profile conform to the natural grasp shape of a hand.

### BACKGROUND OF THE INVENTION

The present invention relates to barcode readers, and more particularly, to an improved handheld barcode reader.

A conventional handheld barcode reader or scanner usually comprises a scanner portion and a handle or grip portion. The two portions are usually molded as a single integral part, or are two separate parts that are fixedly connected to each other. However, such an integral design may have some disadvantages. For example, the scanner portion assumes a fixed angle with the grip portion, thus sometimes it is difficult to scan a barcode that is in an inconvenient position relative to the user. Some electronic components and circuitries of the scanner are housed in the grip portion. If a wireless antenna (e.g., for RFID scanning) is installed in the grip portion, the hand of the user may interfere with the wireless communications.

### SUMMARY OF THE INVENTION

It is an object of the present invention to provide an improve handheld barcode reader, in which a scanner portion can assume various desired angles relative to a grip portion.

It is another object of the present invention to provide an improved handheld barcode reader which is robust and not easy to break, but has a light overall weight.

It is a further object of the present invention to provide an improved handheld barcode reader which brings less fatigue in a user.

It is another object of the present invention to provide an improved handheld barcode reader which can avoid interference with the wireless communications by the user's hand.

According to a first aspect of the present invention, an improved handheld barcode reader is provided, which comprises a grip portion and a scanner portion. In particular, the scanner portion is pivotally connected to the grip portion. Therefore, the scanner portion can assume various desired angle relative to the grip portion so as to scan barcodes that are located in positions that may be inconvenient to conventional handheld scanners.

Preferably, a proper retaining mechanism is provided to positively keep the scanner at the various desired angles.

According to a second aspect of the present invention, an improved handheld barcode reader is provided, which comprises a grip portion and a scanner portion connected to the grip portion. In particular, all components needed for barcode reading are provided in the scanner portion except that a power source for supplying power to said scanner portion is provided in said grip portion. As an alternative, even the power source is also included in the scanner portion. Thus, only the scanner portion need to have a robust design and/or be made of a robust material, while the grip portion can be made of a light material at a lower cost. This may decrease the total weight of the barcode reader. In addition, even if the two portions are inadvertently broken from each other, the components and data in the self-completed scanner portion may remain intact and undamaged.

Preferably, the scanner portion comprises an antenna for wireless communications, such as for RFID scanning, and the wireless communications will not be interfered with by a user's hand holding the grip portion.

According to a third aspect of the present invention, an improved handheld barcode reader is provided, which comprises a grip portion and a scanner portion connected to the grip portion. In particular, the grip portion has a profile substantially conform to a natural grasp shape of a hand. This will create less fatigue to the user's hand after a long time of scanning operations than conventional handheld barcode readers.

### BRIEF EXPLANATIONS OF THE DRAWINGS

The above and other features and advantages will be clearer after reading the detailed description of the preferred embodiments of the present invention with reference to the accompanying drawings, in which:

FIG. 1 is a top plan view schematically illustrating an embodiment of an improved handheld barcode reader according to the present invention; and

FIG. 2 is a front side view schematically illustrating the barcode reader shown in FIG. 1.

### DETAILED DESCRIPTION OF THE INVENTION

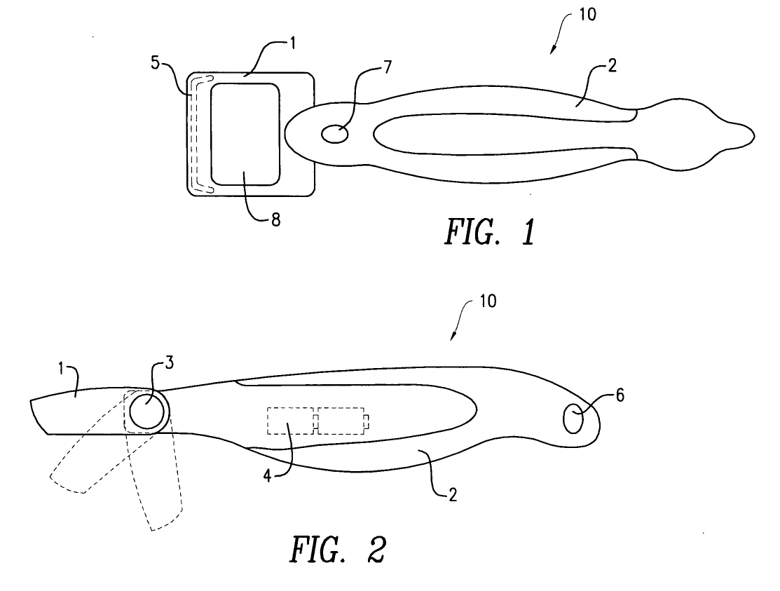

A preferred embodiment of an improved handheld barcode reader 10 according to the present invention is schematically illustrated in FIGS. 1 and 2, which comprises a scanner portion 1 to carry out scanning operations and a handle or grip portion 2 for a user to grasp.

As best shown in FIG. 2, preferably the scanner portion 1 is pivotally connected to the grip portion 2, e.g., by a hinge 3, so that the scanner portion 1 can be swiveled around the hinge 3 to different positions (as shown in dotted lines). In this way, the scanner portion 1 can assume various desired angles relative to the grip portion 2 so as to be able to scan barcodes that may be located at positions that are otherwise inconvenient to scan. For example, in order to scan a barcode located on a back of a heavy box, the user may swivel the scanner portion 1 to a position substantially perpendicular to the grip portion 2, without a need to turn the box around or to go over to the back of the box. The hinge itself can rotate around the grip so that the scanner portion not only swivel up and down but rotate around the grip at the same time.

Preferably, a retaining mechanism may be provided to positively keep the scanner portion 1 at the desired positions. For example, a tight connection may be provided between the hinge 3 and the scanner portion 1 so as to provide some friction therebetween, which may serve as a retaining force to positively retain the scanner portion 1 in various desired positions.

Preferably, according to the teaching of the present invention, the scanner portion 1 is substantially self-completed. More specifically, all of essential electronic components needed for barcode reading operations are included in the scanner portion 1. Alternatively, a power source 4 (such as one or more batteries) that supplies power to the scanner portion 1 may be included in the grip portion 2, so as to make the scanner portion 1 more compact. A power switch 7 for turning on/off the power may also be provided at a convenient position on the grip portion 2.

Preferably, since the grip portion 2 does not include any essential electronic components of the barcode reader 10, the grip portion 2 can be made of a light material with less cost, while only the scanner portion 1 is made of a robust material and/or has a robust design. Even if the two portions 1 and 2 are inadvertently broken from each other (usually at the connection hinge 3), the components and data in the self-completed scanner portion 1 may remain intact and undamaged. Moreover, this may decrease an overall weight of the barcode reader 10 and creates less fatigue to the user. In addition, this may also decrease the costs in designing, manufacturing and assembling of the barcode reader 10.

If the barcode reader 10 comprises an antenna 5 for wireless communications, or for RFID scanning operations, the antenna 5 is preferably installed in the scanner portion 1 as illustrated in FIG. 1. Thus, the user's hand holding the grip portion 2 will not interfere with the wireless communications.

Preferably, the scanner portion 1 includes a display 8 for showing information obtained from read barcodes. Preferably, the display 8 is an LCD display.

Preferably, the grip portion 2 has a profile substantially conform to a natural grasp shape of a hand, so as to minimize the fatigue created to the user's hand after a long time of scanning operations.

Preferably, an eye 6 is provided at a free end of the grip portion 2 for attaching the barcode reader 10 to an external item, e.g., through a ring, a string or a chain.

Though the above has described the preferred embodiments of the present invention, it shall be understood that numerous adaptations, modifications and variations are possible to those skilled in the art without departing the gist of the present invention. Therefore, the scope of the present invention is solely intended to be defined by the accompanying claims.

1. A handheld barcode reader, comprising a grip portion and a scanner portion, wherein said scanner portion is pivotally connected to said grip portion.

2. The barcode reader of claim 1, wherein said grip portion does not include any of electronic components needed for barcode reading.

3. The barcode reader of claim 1, wherein said grip portion has a profile substantially conform to a natural grasp shape of a hand.

4. The barcode reader of claim 1, wherein said scanner portion comprises an antenna for wireless communications.

5. The barcode reader of claim 4, wherein said antenna is capable of RFID scanning.

6. The barcode reader of claim 1, wherein said scanner portion comprises a display.

7. The barcode reader of claim 6, wherein said display is an LCD display.

8. A handheld barcode reader, comprising a grip portion and a scanner portion connected to said grip portion, wherein all components needed for barcode reading are provided in said scanner portion except that a power source for supplying power to said scanner portion is provided in said grip portion.

9. The barcode reader of claim 8, wherein said power source comprises one or more batteries.

10. The barcode reader of claim 8, wherein said scanner portion is pivotally connected to said grip portion.

11. The barcode reader of claim 8, wherein said scanner portion comprises an antenna for wireless communications.

12. The barcode reader of claim 11, wherein said antenna is capable of RFID scanning.

13. The barcode reader of claim 8, wherein said scanner portion comprises a display.

14. The barcode reader of claim 13, wherein said display is an LCD display.

15. The barcode reader of claim 8, wherein said grip portion has a profile substantially conform to a natural grasp shape of a hand.

16. A handheld barcode reader, comprising a grip portion and a scanner portion connected to said grip portion, wherein said grip portion has a profile substantially conform to a natural grasp shape of a hand.

17. The barcode reader of claim 16, wherein said scanner portion comprises an antenna for RFID scanning.

18. The barcode reader of claim 16, wherein said scanner portion comprises a display.

19. The barcode reader of claim 18, wherein said display is an LCD display.

20. The barcode reader of claim 16, wherein said grip portion does not include any of electronic components needed for barcode reading.
